(19) United States
(12) Patent Application Publication
(10) Pub. No.: US 2026/0351959 A1
(43) Pub. Date: Nov. 5, 2026

(54) ELECTRONIC POWER LIMITING DEVICE AND METHOD FOR LIMITING AN OUTPUT POWER

(71) Applicant: Turck Holding GmbH, Halver (DE)

(72) Inventor: Franz Grabowski, Xanten (DE)

(73) Assignee: Turck Holding GmbH, Halver (DE)

(21) Appl. No.: 19/708,975

(22) Filed: Jun. 16, 2026

Related U.S. Application Data
(63) Continuation of application No. PCT/EP2024/087319, filed on Dec. 18, 2024.

(30) Foreign Application Priority Data
Dec. 19, 2023 (DE) 10 2023 135 777.8

(51) Int. Cl. H02H 9/02; H02H 9/04

(52) U.S. Cl. CPC H02H 9/02; H02H 9/04

(57) ABSTRACT

An electronic power limiting device comprises a control unit designed for determining a control signal based on a voltage difference between a first and a second received input voltage at a first and second input of the control unit, wherein the first received input signal represents a voltage at an input of the electronic power limiting device; and a switch element which is designed for receiving the control signal and for ensuring a limited power at an output of the power limiting device.

### CROSS REFERENCE TO RELATED APPLICATION

This application is a continuation application of international patent application PCT/EP2024/087319, filed on Dec. 18, 2024, and designating the U.S., which claims priority to German patent application 10 2023 135 777.8 filed on Dec. 19, 2023, each of which is hereby incorporated by reference in their entireties.

### TECHNICAL FIELD

The present disclosure relates to an electronic power limiting device. Further, the disclosure relates to a method for limiting an output power of an electronic power limiting device.

### BACKGROUND

Some technologies in the field of power limiting devices concentrate on intrinsic safety and explosion protection, to prevent potential dangers due to overloaded components and the development of sparks or heat sources. In sensitive industry branches, such as the chemical and oil industry, the precise control of power capacities can be important.

EP 3 053 237 A1 is directed to an intrinsically safe redundant regulator circuit, comprising a multiplicity of voltage-limiting regulators between a regulated rail and a grounding rail. Each of the multiplicity of voltage-limiting regulators comprises: (i) a shunt regulator component, which is configured such that it limits a voltage between the regulated rail and the grounding rail to a safe limiting voltage value; and (ii) one or more components, wherein one property of each of the one or more components is selected in order to configure the safe limiting voltage value.

EP 2 458 702 A1 describes a converter which has a power limiting circuit with a comparator which is supplied with a voltage that is proportional to an input current. An output of the comparator is connected to a switching circuit for switching off the converter. A reference voltage is applied at a reference input of the comparator. The reference voltage is indirectly proportional to the supply voltage and configured as an output signal of a differential amplifier. The converter is realized as an intrinsically safe device. The converter is encapsulated with an insulating material, for example synthetic resin.

JP 6488432 B1 is directed to an overcurrent protection circuit with a current supply line, a protection transistor, and a voltage generation unit. The current supply line has a first switch and a current detection resistor. The first switch comprises a field effect transistor or an insulating gate-type bipolar transistor. The current detection resistor detects an overcurrent to a load. The current supply line supplies a current to the load from a first current supply source. The protection transistor is connected to the current detection resistor in parallel to each other. The protection transistor has an emitter connected to the current supply line, and a collector connected to the gate of the first switch, and is configured such that the first switch can be switched to an off state wherein the overcurrent to the load is limited.

US 2006/012350 A1 relates to a safety barrier for limiting the current and voltage of an electrical consumer connected downstream thereof. The safety barrier comprises an input terminal and an output terminal and an input and output terminal of a common line, and has at least one voltage and current-limiting device, which comprises a fuse, a voltage-limiting device that is associated with the common line, and a current-limiting device that is connected to the output of the common line and an additional protection circuit that is located in front of the voltage and current-limiting device.

Some of the existing technologies have limitations with regards to their efficiency and reliability. Some of the power limiting devices have deficits when it comes to the input signals to be processed, so no combinatorial multiplication of input signals comprising a voltage and a current can take place.

### SUMMARY

An electronic power limiting device, comprising a power input for receiving an input power being defined by an input voltage and an input current; a power output configured to be connected to a load and to output an output power to the load; a first resistor being connected to the power input in series such that the input voltage and the input current of the power input is applied to the first resistor; a control unit comprising a first input for receiving a measurement voltage, a second input and an output, wherein the second input of the control unit is connected to the power input in series such that the input voltage of the power input is applied to the second input of the control unit; a second resistor being connected in series to the first resistor and the first input of the control unit such that the input current flows from the power input via the first resistor and the second resistor to the first input of the control unit; a third resistor being connected in series to the second resistor and forming a voltage divider together with the second resistor, wherein the first input is connected to a junction of the second resistor and the third resistor for receiving the measurement voltage, and wherein the voltage divider consists of the second resistor and the third resistor; and a switching unit being connected in series to the first resistor via a power line and a node provided in the power line, and being connected in series to the power output such that the input current flows from the power input via the first resistor, the power line and the switching unit to the power output in a first state of the switching unit and such that the input current flowing from the power input via the first resistor towards the power output is interrupted in a second state of the switching unit, wherein the switching unit is connected in series to the output of the control unit; wherein the node acts as a current divider dividing a current flowing from the first resistor to the switching unit solely between the second resistor and the switching unit; wherein the control unit is configured to: determine a control signal based on the measurement voltage and the input voltage, wherein a difference between the input voltage and the measurement voltage is caused by a voltage drop at the first resistor and the second resistor, and wherein determining the control signal comprises determining the difference between the input voltage and the measurement voltage and comparing the determined difference with a predefined threshold value, and output the control signal via the output of the control unit to the switching unit to control an operation of the switching unit thereby limiting the output power at the power output to a predefined maximum output power.

A method for limiting an output power of an electronic power limiting device is provided, the electronic power limiting device including a power input for receiving an input power being defined by an input voltage and an input current; a power output configured to be connected to a load and to output an output power to the load; a first resistor being connected to the power input in series such that the input voltage and the input current of the power input is applied to the first resistor; a control unit comprising a first input for receiving a measurement voltage, a second input and an output, wherein the second input of the control unit is connected to the power input in series such that the input voltage and the input current of the power input is applied to the second input of the control unit; a second resistor being connected in series to the first resistor and the first input of the control unit such that the input current flows from the power input via the first resistor and the second resistor to the first input of the control unit; a third resistor being connected in series to the second resistor and forming a voltage divider together with the second resistor, wherein the first input is connected to a junction of the second resistor and the third resistor for receiving the measurement voltage, and wherein the voltage divider consists of the second resistor and the third resistor; and a switching unit being connected in series to the first resistor via a power line and a node provided in the power line, and being connected in series to the power output such that the input current flows from the power input via the first resistor and the switching unit to the power output in a first state of the switching unit and such that the input current flowing from the power input via the first resistor towards the power output is interrupted in a second state of the switching unit, wherein the switching unit is connected in series to the output of the control unit; wherein the node acts a current divider dividing a current flowing from the first resistor to the switching unit solely between the second resistor and the switching unit. The method comprises determining, at the control unit, a control signal based on a difference between the input voltage and the measurement voltage caused by a voltage drop at the first resistor and the second resistor, and wherein determining the control signal comprises determining the difference between the input voltage and the measurement voltage and comparing the determined difference with a predefined threshold value; and output the control signal via the output of the control unit to the switching unit to control an operation of the switching unit thereby limiting the output power at the power output to a predefined maximum output power.

### BRIEF DESCRIPTION OF THE DRAWINGS

In the drawings:

FIG. 1 schematically shows an electronic power limiting device according to the disclosure;

FIG. 2 schematically shows a further electronic power limiting device according to the disclosure; and

FIG. 3 shows a graph of the limited output power of the electronic power limiting device.

### DESCRIPTION

In the following, details are set forth to provide a more thorough explanation of the disclosure. However, it will be apparent to those skilled in the art that the disclosure can be practiced without these specific details. In other instances, well-known structures and devices are shown in block diagram form or in a schematic view rather than in detail to avoid obscuring the disclosure. In addition, features described hereinafter can be combined with each other, unless specifically noted otherwise. It is also to be understood that other features can be utilized and structural or logical changes can be made without departing from the scope defined by the claims. The following detailed description, therefore, is not to be taken in a limiting sense.

Further, equivalent or like elements or elements with equivalent or like functionality are denoted in the following description with the same or like reference numerals. As the same or functionally equivalent elements are given the same or like reference numbers in the figures, a repeated description for elements provided with the same or like reference numbers can be omitted. Hence, descriptions provided for elements having the same or like reference numbers are mutually exchangeable unless indicated otherwise.

Directional terminology, such as “top”, “bottom”, “above”, “below”, “front”, “back”, “behind”, “leading”, “trailing”, “over”, “under”, etc., can be used with reference to the orientation of the figures and/or elements being described. Because the features can be positioned in a number of different orientations, the directional terminology is used for purposes of illustration and is in no way limiting. In some instances, directional terminology can be exchanged with equivalent directional terminology based on the orientation of a feature so long as the general directional relationships between elements, and the general purpose thereof, is maintained.

In the present disclosure, expressions including ordinal numbers, such as “first”, “second”, and/or the like, can modify various elements. However, such elements are not limited by the above expressions. For example, the above expressions do not limit the sequence and/or importance of the elements. The above expressions are used merely for the purpose of distinguishing an element from the other elements. For example, a first feature and a second feature indicate different features, although both are features. For further example, a first element could be termed a second element, and similarly, a second element could also be termed a first element without departing from the scope of the present disclosure.

Neither the drawings nor the following descriptions thereof are intended to limit the scope of the disclosure and are provided for exemplary purposes only.

One possible object of the present disclosure can be to provide an electronic power limiting device and a method for limiting an output power of an electronic power limiting device, both of which are suitable for enriching the prior art.

The object can be solved by an electronic power limiting device. The electronic power limiting device comprises a power input for receiving an input power being defined by an input voltage and an input current. The electronic power limiting device comprises a power output configured to be connected to a load and to output an output power to the load. The electronic power limiting device comprises a first resistor being connected to the power input in series such that the input voltage and the input current of the power input is applied to the first resistor. The electronic power limiting device comprises a control unit comprising a first input for receiving a measurement voltage, a second input and an output, wherein the second input of the control unit is connected to the power input in series such that the input voltage of the power input is applied to the second input of the control unit. The electronic power limiting device comprises a second resistor being connected in series to the first resistor and the first input of the control unit such that (during operation of the device/when the device is in operation) the input current flows from the power input via the first resistor and the second resistor to the first input of the control unit. The electronic power limiting device comprises a third resistor being connected in series to the second resistor and forming a voltage divider together with the second resistor. The electronic power limiting device comprises switching unit being connected in series to the first resistor and the power output such that (during operation of the device/when the device is in operation) the input current flows from the power input via the first resistor and the switching unit to the power output in a first state of the switching unit and such that the input current flowing from the power input via the first resistor towards the power output is interrupted in a second state of the switching unit, wherein the switching unit is connected in series to the output of the control unit. The control unit is configured to determine a control signal based on the measurement voltage and the input voltage. The control unit is configured to output the control signal via the output of the control unit to the switching unit to control an operation of the switching unit thereby limiting the output power at the power output to a predefined maximum output power.

The object can be solved by a method for limiting an output power of an electronic power limiting device. The electronic power limiting device comprises a power input for receiving an input power being defined by an input voltage and an input current. The electronic power limiting device comprises a power output configured to be connected to a load and to output an output power to the load. The electronic power limiting device comprises a first resistor being connected to the power input in series such that the input voltage and the input current of the power input is applied to the first resistor. The electronic power limiting device comprises a control unit comprising a first input for receiving a measurement voltage, a second input and an output, wherein the second input of the control unit is connected to the power input in series such that the input voltage of the power input is applied to the second input of the control unit. The electronic power limiting device comprises a second resistor being connected in series to the first resistor and the first input of the control unit such that (during operation of the device/when the device is in operation) the input current flows from the power input via the first resistor and the second resistor to the first input of the control unit. The electronic power limiting device comprises a third resistor being connected in series to the second resistor and forming a voltage divider together with the second resistor. The electronic power limiting device comprises a switching unit being connected in series to the first resistor and the power output such that (during operation of the device/when the device is in operation) the input current flows from the power input via the first resistor and the switching unit to the power output in a first state of the switching unit and such that the input current flowing from the power input via the first resistor towards the power output is interrupted in a second state of the switching unit, wherein the switching unit is connected in series to the output of the control unit. The method comprises determining, at the control unit, a control signal based on the measurement voltage and the input voltage. The method comprises outputting the control signal via the output of the control unit to the switching unit to control an operation of the switching unit thereby limiting the output power at the power output to a predefined maximum output power

The switch element can be or comprise a bipolar transistor or a MOSFET transistor, optionally a P-channel MOSFET transistor.

The control unit can be or comprise a controllable or adjustable Zener diode.

A difference between the input voltage and the measurement voltage can be caused by a voltage drop at the first resistor and the second resistor.

Determining the control signal comprises determining the difference between the input voltage and the measurement voltage.

Determining the control signal comprises comparing the determined difference with a predefined threshold value.

The control signal may cause the switching element to reduce, optionally interrupt, the current and/or voltage reaching the power output (thereby limiting the output power).

Optionally, the control signal can be output to the switching element as soon as the difference between the input voltage and the measurement voltage reaches the predefined threshold value, i.e. the control can be output to the switching element when the difference between the input voltage and the measurement voltage is equal to or larger than the predefined threshold value.

The electronic power limiting device can comprise a fourth resistor, wherein the control unit can be connected via its output to the fourth resistor.

The electronic power limiting device can comprise a diode, wherein the diode can be connected to the output of the control unit and to the switch element, and wherein the diode can be provided in a reverse direction with respect to the control signal.

The electronic power limiting device can comprise a further control unit comprising a further first input for receiving a further measurement voltage, a further second input and a further output, wherein the further second input of the further control unit can be connected to the power input in series such that the input voltage and the input current of the power input is applied to the further second input of the further control unit. A further second resistor can be connected in series to the first resistor and the further first input of the further control unit such that (during operation of the device/when the device is in operation) the input current flows from the power input via the first resistor and the further second resistor to the further first input of the further control unit. A further third resistor can be connected in series to the further second resistor and forming a further voltage divider together with the further second resistor. A further switching unit can be connected in series to the switching unit and the power output such that (during operation of the device/when the device is in operation) the input current flows from the power input via the first resistor, the switching unit and the further switching unit to the power output in the first state of the switching unit and a first state of the further switching unit and such that the input current flowing from the power input via the first resistor towards the power output is interrupted in a second state of the further switching unit, wherein the further switching unit can be connected in series to the further output of the further control unit. The further control unit can be configured to determine a further control signal based on the further measurement voltage and the input voltage. The further control unit can be configured to output the further control signal via the further output of the further control unit to the further switching unit to control an operation of the further switching unit thereby limiting the output power at the power output to the predefined maximum output power.

The predefined maximum output power can be 5 Watts or less.

The input voltage can be 60 V or less.

The first resistor can provide/have a resistance of 100 Ω or less.

A casting component can be provided, the casting component comprising the electronic power limiting device and a load connected to the power output of the electronic power limiting device.

An electronic power limiting device can be defined as a unit which monitors, controls and/or limits the output power of a system and/or a device. The electronic power limiting device can comprise sensors, switch elements and/or switching circuits, and other electronic components in order to monitor a power and to intervene if a predefined threshold is exceeded. This electronic power limiting device can comprise electronic components such as resistors, transistors, diodes or circuits, optionally to limit the power to a predetermined or predefined safe operating range.

A “control unit” inside an electronic power limiting device can be a component which takes on the monitoring and control of the power output of the electronic power limiting device. It can use sensors to detect data about current (intensity), voltage and/or other relevant parameters, and process these data. The sensors can be designed as corresponding electronic components for detecting the relevant parameters. Based on one or more predefined thresholds, the control unit can be configured to control, optionally regulate, the output power in that it sends control signals to other components, optionally switch elements, of the power limiting device in order to adjust, to switch and/or to limit the power at the output of the power limiting device.

A switch element of an electronic power limiting device can be a component which is designed to check and/or to control the provision of power. The switch element can be present in the form of a semiconductor, a transistor or a different switching element. The switch element can be configured to open or close the current path to control, optionally regulate, the output power as required. If one or more threshold values are exceeded or the output power limits are reached, the switch element can be activated and act in order to limit or control, optionally regulate, the output power. Optionally, the current flow can be interrupted completely.

Optionally, among other things, a real power limitation can be implemented by means of the electronic power limiting device according to the disclosure. Here, the control unit can be used both for the evaluation of a voltage signal and a current signal. The electronic power limiting device can be dimensioned for intrinsic safety. In addition, a reduced approval outlay for use in potentially explosive environments can be created for the devices with the electronic power limiting device according to the disclosure. Furthermore, the downstream-connected components, i.e. the load, can likewise be protected by the electronic power limiting device.

The electronic power limiting device can be provided for the intrinsic safety ignition protection category. Due to the configuration of electrical components for the “intrinsically safe” ignition protection category using the electronic power limiting device according to the disclosure, this can be designed such that it can be used and can operate in a potentially explosive environment without causing dangerous sparking or temperature evolution which could trigger an explosion. Here, the electrical energy of the electrical component, optionally the power consumption, can be kept at a safe level, to minimize the risk of an ignition. The power to be output can be less than 1 W, optionally less than 400 mW.

The electronic power limiting device can be provided for extra-low voltages. Due to the use of extra-low voltages, the power that can potentially be provided can be reduced so that no ignition of explosive atmospheres takes place. Optionally, the risk of sparking or hot surfaces, which could trigger an explosion, can be reduced considerably. Furthermore, due to the use of extra-low voltages, the likelihood of dangerous situations, such as electric arcs for example, can be minimized. In addition, applicable safety standards and regulations in potentially explosive environments can be fulfilled.

At least one further control unit can be connected in parallel to the control unit and one further switch element can be connected in series to the switch element. As a result of this, a cascade can be built, by means of which it can be possible to achieve redundancies and fail-safety for use in potentially explosive areas can be increased and ensured in an improved manner. By means of redundancy, it can be possible to ensure improved safety, which extends to use in a Zone 0, for example to be able to operate a sensor inside a gasholder.

The switch element can be designed as a bipolar transistor or MOSFET transistor, optionally as a P-channel MOSFET transistor. The PNP transistor provided can be a bipolar transistor. Alternatively, if the electronic power limiting device is correspondingly adapted, an NPN transistor can also be provided.

The control unit can be designed as a controllable Zener diode. By means of the Zener diode, a stable output voltage can be provided, which can be independent of changes of the input voltage or load fluctuations. Furthermore, the implementation of the control unit using a Zener diode can constitute a circuit which can be comparatively easy to integrate, which can be implemented by means of a simple series circuit using a series resistor and can generate a stable output voltage. In addition, Zener diodes can be capable of discharging and limiting voltage peaks. Due to a low current consumption in forward operation, the energy consumption in the circuit can be minimized.

The power can be regulated by means of the control unit. The control unit can comprise a first and a second input for receiving first and second input signals. Furthermore, the control unit can comprise an output for providing the control signal (optionally the regulator signal).

The control unit can be controlled by means of a voltage difference which comes about both due to the voltage and due to the current intensity.

The control unit can be a regulating unit.

The first received input signal, i.e. the measurement voltage, can be derived from a voltage drop across the first resistor, wherein the first resistor can be connected to the input of the electronic power limiting device. The first resistor can be designed as a low-resistance resistor to reduce the power loss caused by the first resistor. The first resistor can be designed as a shunt resistor, the voltage drop caused by which can depend on the input current of the electronic power limiting device. The first resistor can have a resistance value in a range of for example 20 Ω to 100 Ω.

Additionally, the first received input signal, i.e. the measurement voltage, can be derived by means of a voltage divider from the output voltage of the first resistor, wherein the voltage divider can comprise a second resistor and a third resistor. The second and third resistors can be designed as high-resistance resistors with respect to the first resistor.

The control unit can be connected via an output to a fourth resistor and the switch element. The fourth resistor can be wired up to the control unit in a series connection. By means of the fourth resistor, the current through the control unit and for activating the switch unit can be limited to intrinsically safe values, i.e. one or more predefined values.

A diode can be connected between the output of the control unit and the switch element, wherein the diode can be connected in the reverse direction. By means of the diode, back-flow of the current can be prevented in the event of a short circuit of the control unit.

The electronic power limiting device can be or comprise one or more switching circuits. The electronic power limiting device can be constructed on a printed circuit board, i.e. the printed circuit board can comprise the electronic power limiting device.

The control unit can be an integrated circuit.

Optionally, by means of a measuring shunt, by means of which a voltage is provided from the current intensity, and a voltage divider, which maps the voltage, a current and voltage are combined and provided as voltage difference between the inputs of one or more control unit(s), in order thus to regulate one or more transistor(s) for optionally redundant power limitation. The combination includes mixing, which describes a voltage difference, based on which voltage difference the control unit(s) are controlled and which voltage difference relates to both current and voltage. The number of fault redundancies can be increased as desired, depending on the requirements of a particular class of potentially explosive sites. To this end, further control units and voltage dividers can be connected in parallel and further switch elements can be connected in series.

The electronic power limiting device 10 is illustrated schematically in FIG. 1.

The electronic power limiting device 10 comprises a power input (or port) 14 for receiving an input power being defined by an input voltage U_{VIN} and an input current I_{CIN}.

The electronic power limiting device 10 comprises a power output 17 connected to a load 30 (for example a sensor for use in a potentially explosive area) and configured to output an output power Pₒᵤₜ to the load 30.

The electronic power limiting device 10 comprises a first resistor 19. The first resistor 19 is connected to the power input 14 in series such that the input voltage U_{VIN} and the input current I_{CIN} of the power input 14 is applied to the first resistor 19.

The electronic power limiting device 10 comprises a control unit 11 comprising a first input 12 for receiving a measurement voltage U_{MES}, a second input 13 and an output 16. The second input 13 of the control unit 11 is connected to the power input 14 in series such that the input voltage U_{VIN} of the power input 14 is applied to the second input 13 of the control unit 11.

The electronic power limiting device 10 comprises a second resistor 20 being connected in series to the first resistor 19 and the first input 12 of the control unit 11 such that the input current I_{CIN} flows from the power input 14 via the first resistor 19 and the second resistor 20 to the first input 12 of the control unit 11.

The electronic power limiting device 10 comprises a third resistor 21 being connected in series to the second resistor 20 and forming a voltage divider together with the second resistor 20.

The electronic power limiting device 10 comprises a switching unit 15 being connected in series to the first resistor 19 and the power output 17 such that the input current I_{CIN} flows from the power input 14 via the first resistor 19 and the switching unit 15 to the power output 17 in a first state of the switching unit 15 and such that the input current I_{CIN} flowing from the power input 14 via the first resistor 19 towards the power output 17 is interrupted in a second state of the switching unit 15. The switching unit 15 is connected in series to the output 16 of the control unit 11.

The control unit 11 is designed for providing a regulator signal based on a formed voltage difference that is created from a first and a second received input signal at a first and second input 12, 13 of the control unit 11. The first input signal received by the control unit 11 represents the current I_{CIN} at the first input 14 of the electronic power limiting device 10. The input signals at the first input 12 and second input 13 of the control unit 11 are measured and compared with an internal reference, i.e. the predefined threshold value U_{REF}. An internal reference may for example be U_{REF}=1.23 V. As illustrated in FIG. 1, the control unit 11 comprises a controllable Zener diode, but the disclosure is not limited to such a regulator type. The switch element 15 can be designed as a bipolar transistor or a MOSFET transistor, optionally as a P-channel MOSFET transistor. The first resistor 19 can be a shunt resistor, by means of which a measure for the current intensity as voltage value for the control unit 11 is provided. The second and/or third resistors 20, 21 can have a high-resistance. The first resistor 19 can have low-resistance in comparison to the second and/or third resistor 20, to ensure low power loss. That is, the input current I_{CIN} at the power input 14 of the electronic power limiting device 10 flows through the first resistor 19 and the first resistor 19 causes a corresponding voltage drop. The first received input signal can be derived from the voltage drop across the first resistor 19 and the second resistor 20.

The control unit 11 is configured to determine a control signal based on the measurement voltage U_{MES} and the input voltage U_{VIN}. More specifically, the control unit 11 is configured to determine a difference between the input voltage U_{VIN} and the measurement voltage U_{MES} caused by a voltage drop at the first resistor 19 and the second resistor 20, to compare the determined difference with a predefined threshold value U_{REF} and to output the control signal via the its output 16 (via the diode 18) to the transistor 15 when the difference exceeds the predefined threshold value U_{REF} (thereby regulating the transistor 15 and thus limiting the output power P_{OUT}).

The control unit 11 is configured to output the control signal via the output 16 of the control unit 11 to the switching unit 15 to control an operation of the switching unit 15 thereby limiting the output power at the power output 17 to a predefined maximum output power.

The electronic power limiting device 10 maps the output power (current times voltage) onto a voltage difference, which is then the input variable of the control unit 11. In other words, the power limiting device 10 does not only limit the output current or the output voltage, but limits the output power P_{OUT} by monitoring both, the input voltage U_{VIN} and the input current I_{CIN}

The following control law may be used:

U_{VIN}−U_{MES}<=U_{REF}

The measurement voltage U_{MES} can be defined as follows:

UR19=I_{CIN}*R19

U_{MES}=(U_{VIN}−UR19)*R21/ (R20+R21)

The electronic power limiting device 10 furthermore has the fourth resistor 22. The fourth resistor 22 is connected to the output 16 of the control unit 11 and to the ground potential. By means of the fourth resistor 22, the current through the control unit 11 can be limited.

In addition, a diode 18 can be provided in the connection between the output 16 of the control unit 11 and the switch element 15. The diode 18 is connected in the reverse direction with respect to the control signal. By means of the diode 18, a current flow can be limited in the event of a short circuit of the control unit 11.

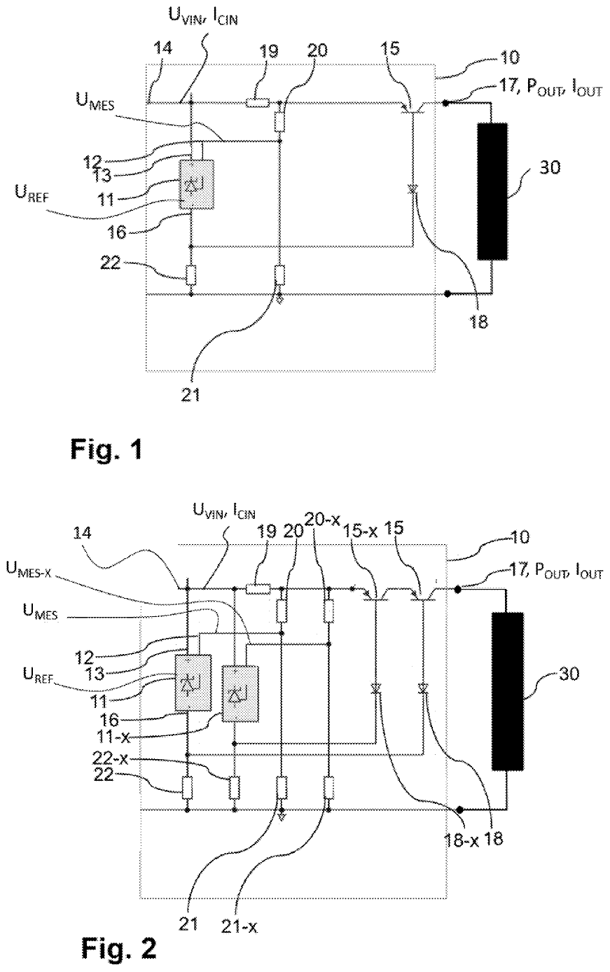

The electronic power limiting device 10 illustrated schematically in FIG. 2 corresponds to the power limiting device 10 of FIG. 1 and was expanded by a further control unit 11-x, a further switch unit 15-x and corresponding resistors 20-x, 21-x, 22-x.

As shown in FIG. 2, a redundant configuration of the switch unit 15 and the control unit 11 and a corresponding supply via the resistors can be provided.

The further control unit 11-x can be connected in parallel to the control unit 11 and the further switch element 15-x can be connected in series to the switch element 15.

More specifically, the electronic power limiting device 10 comprises a further control unit 11-x comprising a further first input 12-x for receiving a further measurement voltage U_{MES-X}, a further second input 13-x and a further output 16-x, wherein the further second input 13-x of the further control unit 11-x is connected to the power input 14 in series such that the input voltage U_{VIN} and the input current I_{CIN} of the power input 14 is applied to the further second input 13-x of the further control unit 11-x.

The electronic power limiting device 10 comprises a further second resistor 20-x being connected in series to the first resistor 19 and the further first input 12-x of the further control unit 11-x such that the input current I_{CIN} flows from the power input 14 via the first resistor 19 and the further second resistor 20-x to the further first input 12-x of the further control unit 11-x.

The electronic power limiting device 10 comprises a further third resistor 21-x being connected in series to the further second resistor 20-x and forming a further voltage divider together with the further second resistor 20-x.

The electronic power limiting device 10 comprises a further switching unit 15-x being connected in series to the switching unit 15 and the power output 17 such that the input current I_{CIN} flows from the power input 14 via the first resistor 19, the switching unit 15 and the further switching unit 15-x to the power output 17 in the first state of the switching unit 15 and a first state of the further switching unit 15-x and such that the input current I_{CIN} flowing from the power input 14 via the first resistor 19 towards the power output 17 is interrupted in a second state of the further switching unit 15-x, wherein the further switching unit 15-x is connected in series to the further output 16-x of the further control unit 11-x.

The further control unit 11-x is configured to determine a further control signal based on the further measurement voltage U_{MES-X} and the input voltage U_{VIN}, and output the further control signal via the further output 16-x of the further control unit 11-x to the further switching unit 15-x to control an operation of the further switching unit 15-x thereby limiting the output power P_{OUT} at the power output 17 to the predefined maximum output power.

Thus, a cascade is built, by means of which it is possible to achieve redundancies, and improved fail-safety for use in a potentially explosive area can be increased and ensured in an improved manner.

The number of cascades shown in FIG. 2 represents no limitation for the number of cascades that can be implemented according to the disclosure. Rather, further control units 11, 11-x and switch units 15, 15-x can be provided.

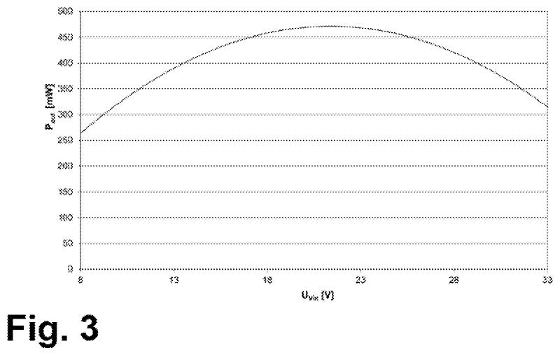

A graph of the limited output power is plotted in FIG. 3 as a function of the input voltage U_{VIN} of the electronic power limiting device 10, e.g. as shown in FIG. 1.

In the graph, the limited output power of the electronic power limiting device 10 is plotted as a function of the input voltage U_{Vin} at the power input 14 of the electronic power limiting device 10 and by means of the output current I_{OUT} at the power output 17 of the electronic power limiting device 10.

The formulae used for calculation are:

I_{OUT}=(U_{REF}*(R19+R20+R21)−UVIN*(R19+R20))/(R19*R21)

P_{OUT}=(U_{VIN}−UR19)*I_{OUT}

In the example, resistors of R19=27 Ω, R20=10 kΩ, R21=330 kΩ and R22=47 kΩ, and a regulator 11 of the LM4041 type and a diode 18 of the BAS521 type and a switch element 15 of the DXT2013P5 type are provided.

The shape of the power-limited output curve is approximately constant.

The graph shows that as the input voltage U_{VIN} grows, a maximum value of the output power P_{OUT} is reached and not exceeded. In the example, this value is at less than 500 mW; depending on the field of use, the maximum power reached can be adjusted by means of a suitable choice and dimensioning of the components of the power limiting device 10. Unlike in the case of the use of a load switch, it is possible to achieve a steady shape of the curve.

The maximum output power of the electronic power limiting device 10 can be further adjustable, for example by adjustable potentiometers. The power limiting device 10 can therefore be adapted to its intended use, for example for higher voltages and/or higher powers than in potentially explosive areas.

### LIST OF REFERENCE CHARACTERS

10 Power limiting device
11 Control unit
11-x Further control unit
12 first input, control unit
13 second input, control unit
14 power input, power limiting device
15 switch element
15-x further switch element
16 output of the control unit
17 power output, power limiting device
18 diode
19 first resistor
20 second resistor
21 third resistor
22 fourth resistor
30 load

What is claimed is:

1. An electronic power limiting device, comprising:
a power input for receiving an input power being defined by an input voltage and an input current;
a power output configured to be connected to a load and to output an output power to the load;
a first resistor being connected to the power input in series such that the input voltage and the input current of the power input is applied to the first resistor;
a control unit comprising a first input for receiving a measurement voltage, a second input and an output, wherein the second input of the control unit is connected to the power input in series such that the input voltage of the power input is applied to the second input of the control unit;
a second resistor being connected in series to the first resistor and the first input of the control unit such that the input current flows from the power input via the first resistor and the second resistor to the first input of the control unit;
a third resistor being connected in series to the second resistor and forming a voltage divider together with the second resistor, wherein the first input is connected to a junction of the second resistor and the third resistor for receiving the measurement voltage, and wherein the voltage divider consists of the second resistor and the third resistor; and
a switching unit being connected in series to the first resistor via a power line and a node provided in the power line, and being connected in series to the power output such that the input current flows from the power input via the first resistor, the power line and the switching unit to the power output in a first state of the switching unit, and such that the input current flowing from the power input via the first resistor towards the power output is interrupted in a second state of the switching unit, wherein the switching unit is connected in series to the output of the control unit;
wherein the node acts as a current divider dividing a current flowing from the first resistor to the switching unit solely between the second resistor and the switching unit;
wherein the control unit is configured to:
determine a control signal based on the measurement voltage and the input voltage, wherein a difference between the input voltage and the measurement voltage is caused by a voltage drop at the first resistor and the second resistor, and wherein determining the control signal comprises determining the difference between the input voltage and the measurement voltage and comparing the determined difference with a predefined threshold value, and
output the control signal via the output of the control unit to the switching unit to control an operation of the switching unit thereby limiting the output power at the power output to a predefined maximum output power.

2. The electronic power limiting device according to claim 1, wherein the switching unit is or comprises a bipolar transistor or a MOSFET transistor, optionally a P-channel MOSFET transistor.

3. The electronic power limiting device according to claim 1, wherein the control unit is or comprises a controllable Zener diode.

4. The electronic power limiting device according to claim 1, comprising a fourth resistor, wherein the control unit is connected via its output to the fourth resistor.

5. The electronic power limiting device according to claim 1, comprising a diode, wherein the diode is connected to the output of the control unit and to the switching unit, and wherein the diode is provided in a reverse direction with respect to the control signal.

6. The electronic power limiting device according to claim 1, comprising:
a further control unit comprising a further first input for receiving a further measurement voltage, a further second input and a further output, wherein the further second input of the further control unit is connected to the power input in series such that the input voltage and the input current of the power input is applied to the further second input of the further control unit,
a further second resistor being connected in series to the first resistor and the further first input of the further control unit such that the input current flows from the power input via the first resistor and the further second resistor to the further first input of the further control unit;
a further third resistor being connected in series to the further second resistor and forming a further voltage divider together with the further second resistor; and
a further switching unit being connected in series to the switching unit and the power output such that the input current flows from the power input via the first resistor, the switching unit and the further switching unit to the power output in the first state of the switching unit and a first state of the further switching unit and such that the input current flowing from the power input via the first resistor towards the power output is interrupted in a second state of the further switching unit, wherein the further switching unit is connected in series to the further output of the further control unit;
wherein the further control unit is configured to:
determine a further control signal based on the further measurement voltage and the input voltage, wherein a difference between the input voltage and the measurement voltage is caused by a voltage drop at the first resistor and the second resistor, and wherein determining the control signal comprises determining the difference between the input voltage and the measurement voltage and comparing the determined difference with a predefined threshold value, and
output the further control signal via the further output of the further control unit to the further switching unit to control an operation of the further switching unit thereby limiting the output power at the power output to the predefined maximum output power.

7. The electronic power limiting device according to claim 1, wherein the predefined maximum output power is 5 Watts or less.

8. The electronic power limiting device according to claim 1, wherein the input voltage is 60 V or less.

9. The electronic power limiting device according to claim 1, wherein the first resistor provides 100 Ω or less.

10. A casting component, comprising the electronic power limiting device according to claim 1 and a load connected to the power output of the electronic power limiting device.

11. A method for limiting an output power of an electronic power limiting device, the electronic power limiting device including:
a power input for receiving an input power being defined by an input voltage and an input current;
a power output configured to be connected to a load and to output an output power to the load;
a first resistor being connected to the power input in series such that the input voltage and the input current of the power input is applied to the first resistor;
a control unit comprising a first input for receiving a measurement voltage, a second input and an output, wherein the second input of the control unit is connected to the power input in series such that the input voltage and the input current of the power input is applied to the second input of the control unit;
a second resistor being connected in series to the first resistor and the first input of the control unit such that the input current flows from the power input via the first resistor and the second resistor to the first input of the control unit;
a third resistor being connected in series to the second resistor and forming a voltage divider together with the second resistor, wherein the first input is connected to a junction of the second resistor and the third resistor for receiving the measurement voltage, and wherein the voltage divider consists of the second resistor and the third resistor; and
a switching unit being connected in series to the first resistor via a power line and a node provided in the power line, and being connected in series to the power output such that the input current flows from the power input via the first resistor and the switching unit to the power output in a first state of the switching unit, and such that the input current flowing from the power input via the first resistor towards the power output is interrupted in a second state of the switching unit, wherein the switching unit is connected in series to the output of the control unit;
wherein the node acts as a current divider dividing a current flowing from the first resistor to the switching unit solely between the second resistor and the switching unit,
the method comprising:
determining, at the control unit, a control signal based on a difference between the input voltage and the measurement voltage caused by a voltage drop at the first resistor and the second resistor, and wherein determining the control signal comprises determining the difference between the input voltage and the measurement voltage and comparing the determined difference with a predefined threshold value; and
output the control signal via the output of the control unit to the switching unit to control an operation of the switching unit thereby limiting the output power at the power output to a predefined maximum output power.
